(19) United States
(12) Patent Application Publication
(10) Pub. No.: US 2009/0150018 A1
(43) Pub. Date: Jun. 11, 2009

(54) Friction Plausibility Detection Algorithm For a Steering System

(76) Inventors: Andrew Brown, Canton, MI (US); Darrel Recker, Ypsilanti, MI (US); Brad G. Hochrein, Dexter, MI (US); William J. Bouse, Ann Arbor, MI (US)

Correspondence Address: ANGELA M. BRUNETTI, PLLC, 11300 E. CARIBBEAN LN., SCOTTSDALE, AZ, 85255, US

(21) Appl. No.: 12/255,853

(22) Filed: Oct. 22, 2008

Related U.S. Application Data
(60) Provisional application No. 61/012,552, filed on Dec. 10, 2007.

(51) Int. Cl. G06F 17/00

(52) U.S. Cl. 701/29; 701/42

(57) ABSTRACT

A system and method for detecting and identifying friction in a vehicle having an electric power steering system comprising the steps of measuring predetermined vehicle states, estimating vehicle states using predetermined signals to define idealized vehicle states, calculating a confidence factor to be applied to the idealized vehicle states to determine valid idealized vehicle states, comparing the measured predetermined vehicle states to the valid idealized vehicle states to isolate signal data of interest and define an estimate of friction present in the steering system, applying friction boundaries to the estimate of friction present in the steering system, qualifying the estimate of friction, and setting an internal software flag for the purpose of acknowledging the presence of high friction in the event the estimate of friction exceeds the friction threshold boundaries for a predetermined time.

### CROSS REFERENCE

This application claims the benefit of the filing date of U.S. Provisional Application Ser. No. 61/012,552, filed Dec. 10, 2007, entitled Friction Plausibility Detection Algorithm for a Steering System, the entire disclosure of which is hereby incorporated by reference into the present disclosure.

### TECHNICAL FIELD

The present invention relates to a steering system and more particularly to detecting and identifying high friction characteristics in a steering system.

### BACKGROUND

High friction characteristics in a steering system are highly undesirable as they may adversely affect steering system performance. Large increases in friction may lead to degraded steering performance.

In an electric power steering system, there are mechanical and electrical components of hardware. In the event of a failure, it is preferable to have the electrical system fail, or shut-down, resulting in a loss of electric power assist before failure of the mechanical system. This at least maintains the physical integrity of the system, allowing an operator to safely steer a vehicle, even though it may be manual, i.e., without the power assist.

Under the presence of a corrosive liquid, the mechanical portions of a steering system may corrode quickly and lead to a large increase in steering friction. Due to high output torque assist capacity of a steering system, this increase in friction may go unnoticed by a normal driver due to the system powering through the increase in friction. In the event that the torque assist is lost, the vehicle will become difficult to steer, due to the combined effect of loss assist and high friction.

In an electric power system, there is no guarantee that once the mechanical system has corroded the electrical system will not terminate, quite possibly unexpectedly, at some point during a vehicle's journey. There is a need to identify high friction characteristics and alert a vehicle operator in an appropriately safe manner to have the steering system serviced to correct the high friction condition.

### SUMMARY

The inventive subject matter is a method for detecting and identifying a high friction characteristic in a steering system according to the independent claims with variations as described in the dependent claims.

### DESCRIPTION OF DRAWINGS

FIG. 1 is a block diagram representation of the friction plausibility detection algorithm of the inventive subject matter;

FIG. 2 is a graph depicting a comparison of measured lateral acceleration and idealized lateral acceleration according to the inventive subject matter;

FIG. 3 is a graph depicting a comparison of measured total steering force and idealized total steering force according to the inventive subject matter; and

FIG. 4 is a block diagram of a confidence factor calculation according to the inventive subject matter.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DESCRIPTION OF INVENTION

While various aspects of the present invention are described with reference to a particular illustrative embodiment, the invention is not limited to such embodiments, and additional modifications, applications, and embodiments may be implemented without departing from the present invention. In the figures, like reference numbers will be used to illustrate the same components. Those skilled in the art will recognize that the various components set forth herein may be altered without varying from the scope of the inventive subject matter.

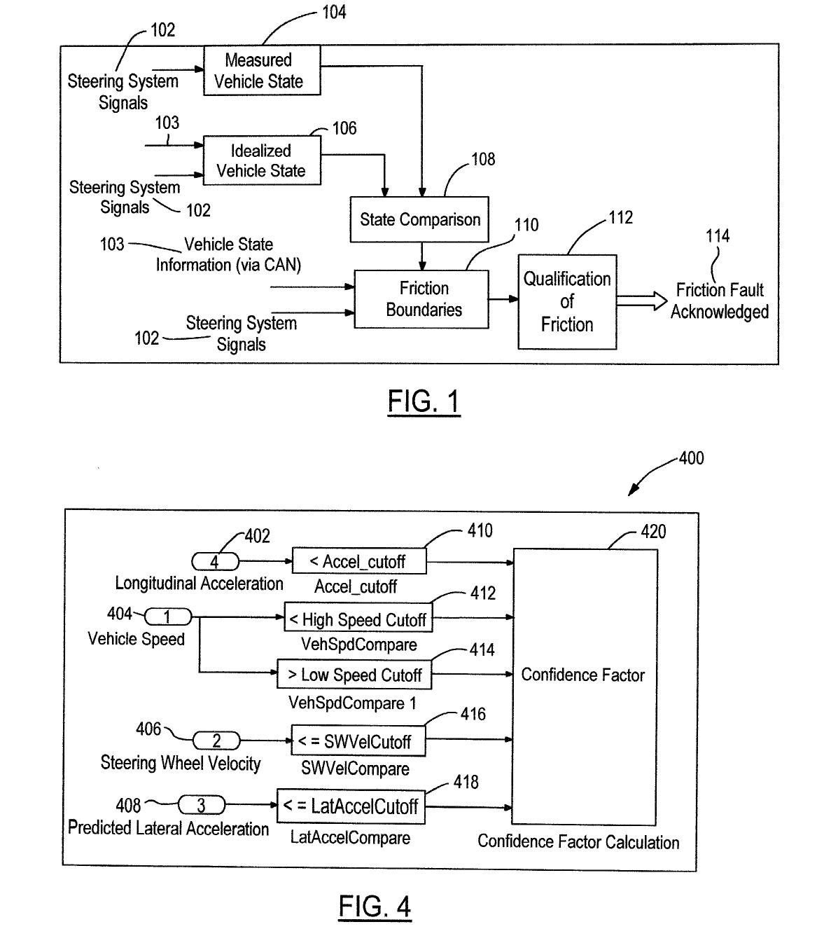

FIG. 1 is a block diagram representation of the friction plausibility detection algorithm 100 of the inventive subject matter. Steering system signals 102 are provided by sensors and signals from an Electric Power Steering (EPS) system. Additionally, external signals 103 from other electronic control modules, such as a Powertrain Control Module and a Brake Control Module, by way of a vehicle's central communication network, also called the CAN, are provided along with steering system signals 102 to determine idealized vehicle states 106. Measured vehicle states 104 and idealized vehicle states 106 developed from of vehicle parameters and various signals are compared 108 and the result is an estimate of friction in the steering system. Friction boundaries 110 are determined from the steering system signals and vehicle state information available from the CAN network on the vehicle. The friction boundaries may vary according to the vehicle's state and current operating conditions. The estimate of friction 108 is compared to the friction boundaries 110 and a qualification of friction determination 112 is made. If the comparison difference is outside of the friction boundaries, a friction fault is acknowledged 114. Each step of the inventive subject matter will be described in greater detail hereinafter.

The measured vehicle states 104 are determined from direct measurement of signals 102 from the steering system. When used in calculations, the measured signals produce a measured vehicle state. The measured vehicle states 104 are considered an actual state of the steering system as the states are directly measuring the output of the steering system, regardless of the friction that may be within the steering system. Any signals available to the EPS may be used to measure the vehicle state. For example, a combination of any of the following signals may be readily available internally from the steering system: Input Torque, Assist Torque, Pinion Angle, Rack Travel, Steering System Gear Ratios, System Temperature, System Performance, and algorithms that run within the steering system.

Specifically, an example of a measured state for an EPS system that may be used in the inventive subject matter is described hereinafter. A rack load signal, R_{load}, representative of a total steering force, may be developed using known rack parameters according to the equation:

R_{load}=(Assist_{Tq}+Input_{Tq})·(1/PinionRatio) (1)

Where, Assist_{Tq} is an assist torque output of the steering system in Nm, Input_{Tq} is an input torque from a vehicle operator in Nm, and PinionRatio, is the rack and pinion ratio in meters (m). The result is a measured rack load, or total steering force, that the system is producing at a current vehicle state for the EPS system

The idealized vehicle state 106 is determined from external signals 103 from the vehicle CAN and predetermined signals 102 from the steering system to predict a given idealized vehicle state, or a value for what the vehicle state should be assuming the presence of a nominal level of friction in the system. The predetermined signals from the steering system may be the same as those described with the measured vehicle state. However, the idealized vehicle state 106 also uses external signals 103, in addition to the measured vehicle state, to determine an idealized state value. The external signals 103 may be received from the vehicle CAN and may include, but are not limited to: Brake Control Module System (lateral acceleration, yaw rate, longitudinal acceleration, etc.), Powertrain Information (engine speed, engine torque, vehicle speed, etc.), Wheel Speeds, ABS and other safety systems, Vehicle temperatures, and System temperatures.

Using the signals and an appropriate governing engineering equation in conjunction with predetermined tunable parameters, a desired vehicle state can be calculated. In order to assure that the idealized value is accurate for the vehicle state, a confidence factor for the idealized state is created and applied as part of the idealized vehicle state calculation 108. The confidence factor is developed from the outside signals from the CAN and the steering system in order to “verify” (provide more or less confidence to the vehicle state) the idealized vehicle state value for predetermined vehicle conditions. The confidence factor will be described later herein.

An example of the prediction of the vehicle state Rack Load is provided by the Equation:

R_{Load}=LoadGain·ay (2)

Where LoadGain is an experimentally determined coefficient to convert lateral acceleration to rack load, ay is the vehicle's lateral acceleration in m/s² as determined by the Equation:

ay=(u²/(Ku²+L))·δ_{f} (3)

Where u is vehicle velocity in m/s, K is an understeer coefficient in 1/(m/s²), L is wheelbase in m, and δ_{f} is front road wheel angle in radians given by:

δ_{f}=SWA·G·(π/180°) (4)

Where SWA is a steering wheel angle in degrees and G is an overall steering ratio.

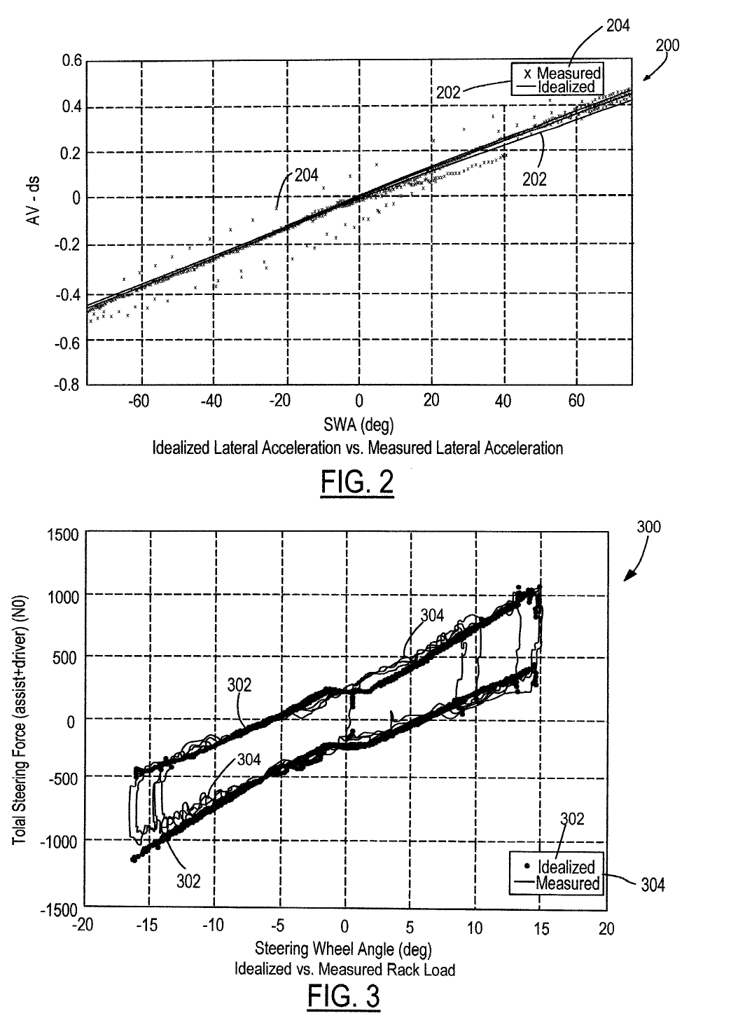

The vehicle state comparison is made mathematically and the result is a difference between the measured and idealized vehicle states. FIG. 2 is a graphical representation of an idealized lateral acceleration and a measured lateral acceleration 200 of the inventive subject matter. The graph clearly shows the idealized lateral acceleration 202 as compared to actual measured lateral acceleration 204. Lateral acceleration being one example of a vehicle state that is applicable to the inventive subject matter. Another example is provided in FIG. 3. FIG. 3 is a graphical representation of rack load 300. The idealized rack load 302 is compared to the measured rack load 304 for multiple steering wheel angle positions. It can be seen in the comparison figures where the predictions closely approximate the actual measured states. For example, in FIG. 2, for low lateral acceleration and quasi steady-state vehicle longitudinal accelerations, the idealized values are very good.

FIG. 4 is a block diagram describing the confidence factor that is applied to the idealized vehicle states discussed above. Prior to the comparison of the idealized and measured states, the inventive subject matter includes determination of a confidence factor, to ensure the idealized vehicle state is a valid value. The confidence factor is used to identify periods when the vehicle is in a stable condition allowing for confidence that the idealized value of the vehicle state will be good, or useful data. For example, the confidence factor should be used to decide when the vehicle meets stable criteria, ensuring that the calculations for the idealized value are valuable to application of the inventive subject matter. The confidence factor calculation 400 uses vehicle measurements, such as longitudinal acceleration 402, vehicle speed 404, steering wheel velocity 406, and the idealized value 408, such as lateral acceleration, as inputs. The inputs are compared to threshold values. For example, the longitudinal acceleration 402 is compared to an acceleration cutoff value 410 and if the threshold is exceeded, the confidence factor is affected. Likewise, vehicle speed may be compared to high 412 and low 414 threshold values; steering wheel velocity 406 is compared to a steering wheel velocity threshold 416; and the idealized value 408 is compared to an applicable threshold 418, i.e., lateral acceleration threshold. Vehicle diagnostics, i.e., fault-free systems, temperature limits, the state of the vehicle electronic control unit, and or other potential vehicle failures may also be taken into consideration when determining the confidence factor. The basic premise is to determine when to apply the comparison so as to ensure valid results for the inventive subject matter. In current vehicle states which indicate unstable driving conditions, the inventive subject matter may not be applied and will be applied at a later time when vehicle stability has resumed. In another example, a fault signal or indication of a sensor failure that would normally provide signal information useful to the inventive subject matter would preclude application of the inventive subject matter so as to avoid incorrect information being used in the idealized vehicle state estimation.

The confidence factor 420 is calculated based on the threshold comparisons and will weigh on the significance of the idealized value as it is used in the system and method of the inventive subject matter. For example, a low confidence factor, i.e., a value much less than one, will result in an idealized value that is not afforded much weight in the determination of friction according to the inventive subject matter. On the other hand, a high confidence factor, i.e., a factor very close to one, will result in a valuable idealized value.

Referring again to FIG. 1, once the idealized and measured states have been calculated, and the confidence factor for the idealized value has been met for a current vehicle state, the idealized and measured states are compared 108. The comparison may be accomplished in a mathematical manner, of which, the methods that may be used are too numerous to mention herein. One skilled in the art is capable of choosing the most applicable mathematical method to employ in developing the algorithm. The general concept is to compare the two values in a way that identifies substantial differences between them. Substantial differences are defined to be differences that can be distinguished from transient, temporary differences. The result is a value that is taken to be an estimate of friction present in the steering system.

An example of such a mathematical comparison may include filtering the measured and idealized values to isolate the frequency content of interest. Typically, the low frequency content is of interest. Filtering is performed to allow consideration of overall level changes between the two signals, ignoring the high frequency changes that occur in the signals. After filtering, an absolute difference between the two signals may be taken.

The estimate of friction will then be subjected to friction boundaries 110 to determine how much friction may be present in the system. For example, if the estimate of friction is greater than a predetermined friction boundary, then high friction may be present in the system. The friction boundaries 110 may be calculated from vehicle state conditions 102, 103 and limits that are tunable. For example, a friction boundary may be calculated according to vehicle speed to allow for a lower friction boundary at low speeds and a higher friction boundary at high speeds. The boundaries are also vehicle dependent, time dependent, and may have a variety of factors taken into consideration in their values.

According to the inventive subject matter, the duration of the existence of the estimate of friction is determined so as to qualify 112 the friction prediction. A predetermined time limit for an estimate of friction that exceeds the friction boundary is used to compare the duration of the existence of the estimate of friction. In the event the estimate of friction exceeds the friction boundary for a time that exceeds the predetermined time limit, the qualification of the friction detection is verified. In such event, a friction-acknowledge bit may be set 114, which may result in a fault signal being initiated by the vehicle. One skilled in the art is capable of applying any one of several methods for using the friction-acknowledge bit to notify an operator and/or a vehicle system that high friction has been detected. The scope of which is dependent upon the type of failure that may occur on which the vehicle and the type of steering system on the vehicle all factor into the desired method of notification.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. The equations may be implemented with a filter to minimize effects of signal noises. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A method for detecting and identifying friction in an electric power steering system for a vehicle, the method comprising the steps of:
measuring predetermined vehicle states;
calculating idealized vehicle states using predetermined steering system signals and signals external to the steering system in predetermined state equations;
comparing the measured predetermined vehicle states to the idealized vehicle states to isolate signal data of interest and define an estimate of friction that is present in the steering system;
applying friction boundaries to the estimate of friction present in the steering system; and
setting an internal software flag for the purpose of acknowledging the presence of high friction in the event the estimate of friction exceeds the friction boundaries.

2. The method as claimed in claim 1 wherein the step of calculating idealized vehicle states using predetermined steering system signals and signals external to the steering system in predetermined state equations further comprises the step of calculating a confidence factor for the idealized vehicle states for a current vehicle state.

3. The method as claimed in claim 2 wherein the step of calculating a confidence factor further comprises the steps of:
identifying current vehicle states;
comparing identified current vehicle states to threshold values;
establishing a confidence factor; and
applying the confidence factor to the idealized vehicle states thereby defining a value to the validity of the idealized vehicle states.

4. The method as claimed in claim 3 wherein the step of identifying current vehicle states further comprises identifying vehicle states from the group consisting of; longitudinal acceleration, vehicle speed, steering wheel velocity, and the idealized vehicle state.

5. The method as claimed in claim 4 wherein the step of comparing identified current vehicle states to threshold values further comprises the step of considering vehicle diagnostics including any fault or failure indications that may be present in a control system for the vehicle.

6. The method as claimed in claim 1 wherein the step of comparing the measured predetermined vehicle states to the idealized vehicle states further comprises applying a mathematical operation to the measured and idealized vehicle states to identify substantial differences thereby defining the estimate of friction.

7. The method as claimed in claim 1 wherein the step of applying friction boundaries to the estimate of friction further comprises the step of calculating the friction boundaries based on current vehicle states.

8. The method as claimed in claim 1 wherein the step of applying friction boundaries to the estimate of friction further comprises the step of qualifying the estimate of friction.

9. The method as claimed in claim 8 wherein the step of qualifying the estimate of friction further comprises the steps of:
determining a duration of time that the existence of the estimate of friction has exceeded a friction boundary; and
defining a time threshold value whereby the estimate of friction is deemed valid upon determination that the determined duration of time exceeds the time threshold value.

10. The method as claimed in claim 1 wherein the step of measuring predetermined vehicle states further comprises the step of calculating at least one predetermined vehicle state from a plurality of signals available from the electronic power steering system.

11. A system for detecting friction plausibility in a vehicle having an electric power steering system, the system comprising:
a central communication control network providing signals representative of a plurality of vehicle states;
an electric power steering system providing steering system signals; and
a controller for measuring vehicle states, calculating idealized vehicle states using predetermined steering system signals and signals external to the steering system in predetermined state equations, comparing the measured predetermined vehicle states to the idealized vehicle states to isolate signal data of interest and define an estimate of friction present in the steering system, applying friction boundaries to the estimate of friction present in the steering system, and setting an internal software flag for the purpose of acknowledging the presence of high friction in the event the estimate of friction exceeds friction threshold boundaries for a predetermined time threshold.

12. The system as claimed in claim 11 wherein the steering system signals are used in calculations by the controller for measuring vehicle states.

13. The system as claimed in claim 11 wherein signals external to the steering system and steering system signals are used in calculations by the controller for calculating idealized vehicle states.

14. The system as claimed in 13 wherein the controller calculates a confidence factor for the idealized vehicle state for a current vehicle state.

15. The system as claimed in claim 14 wherein the confidence factor calculation further comprises:
identifying current vehicle states;
comparing identified current vehicle states to predetermined threshold values;
establishing a confidence factor; and
applying the confidence factor to the idealized vehicle state thereby defining a value to the validity of the idealized vehicle state.

16. The system as claimed in claim 11 wherein the controller compares the measured predetermined vehicle states to the idealized vehicle states by applying a mathematical operation to the measured and idealized states to identify differences thereby defining the estimate of friction.

17. The system as claimed in claim 11 wherein the controller qualifies the estimate of friction by determining a duration of time the estimate of friction exceeds a friction boundary and defining a time threshold value for the duration of time the estimate of friction exceeds the friction boundary, whereby the estimate of friction is deemed valid upon determination of the duration of time the estimate of friction exceeds the friction boundary exceeds the time threshold value.

18. A method for detecting and identifying friction in a vehicle having an electric power steering system, the method comprising the steps of:
measuring predetermined vehicle states;
calculating idealized vehicle states using steering system signals and signals external to the steering system in predetermined state equations;
calculating a confidence factor to be applied to the idealized vehicle states to determine valid idealized vehicle states;
comparing the measured predetermined vehicle states to the valid idealized vehicle states to isolate signal data of interest and define an estimate of friction present in the steering system;
applying friction boundaries to the estimate of friction present in the steering system;
qualifying the estimate of friction; and
setting an internal software flag for the purpose of acknowledging the presence of high friction in the event the estimate of friction exceeds the friction boundaries for a predetermined amount of time.

19. The method as claimed in claim 18 wherein the step of calculating a confidence factor further comprises the steps of:
identifying current vehicle states;
comparing identified current vehicle states to threshold values;
establishing a confidence factor; and
applying the confidence factor to the idealized vehicle states thereby defining valid idealized vehicle states.

20. The method as claimed in claim 19 wherein the step of qualifying the estimate of friction further comprises the steps of:
determining a duration of time the estimate of friction exceeds applied friction boundaries; and
defining a time threshold value, whereby the estimate of friction is deemed valid upon determination of the duration of time the estimate of friction exceeds the applied friction boundaries is greater than time threshold value.
